(19) United States
(12) Patent Application Publication
(10) Pub. No.: US 2024/0338717 A1
(43) Pub. Date: Oct. 10, 2024

(54) PREDICTIVE NEW PRODUCT DEVELOPMENT METHOD AND DEVICE

(71) Applicant: Impactive AI.lnc, Pohang-si, Gyeongsangbuk-do (KR)

(72) Inventors: Doo Hee CHUNG, Pohang-si, Gyeongsangbuk-do (KR); Chan Gyuee LEE, Jeju-si, Jeju-do (KR); Sung Min YANG, Seoul (KR)

(21) Appl. No.: 18/556,697

(22) PCT Filed: Apr. 10, 2023
(86) PCT No.: PCT/KR2023/004811

§ 371 Date: Oct. 23, 2023

(30) Foreign Application Priority Data
Jun. 27, 2022 (KR) 10-2022-0078128

(51) Int. Cl. G06Q 30/0202

(52) U.S. Cl. CPC G06Q 30/0202

(57) ABSTRACT

The present disclosure relates to a predictive new product development method. The predictive new product development method includes: calculating a new product differentiation index (PDI) by calculating a consumer satisfaction coefficient for each feature of a new product and a degree of differentiation of each feature through a differentiation index calculation unit; calculating a demand creation index (DCI) through a relative ratio of sales volume generated by the new product compared to a predecessor product by a demand creation index calculation unit; building a demand forecasting model through Gaussian process regression of the calculated new product differentiation index (PDI) and the calculated demand creation index (DCI) by a demand forecasting model building unit; and deriving an optimal profile for the new product using the demand forecasting model through an optimal profile deriving unit.

### BACKGROUND

### Technical Field

The present disclosure relates to a predictive new product development method and device, and in particular, to a predictive new product development method and device for developing a model that predicts the effect of a combination of differentiated features of a new product on initial sales volume after launch, and inductively proposing a new product profile that maximizes demand through the model.

### Background Art

The ability to develop new products that meet consumer expectations and needs is becoming very important. New product development is a crucial means for increasing market share in a competitive and complex market where consumer preferences change rapidly, enhancing a company's competitiveness and reputation.

In line with this trend, many companies make various investments in new product development to lay the foundation for sustainable management, but most of the existing new product development processes have a deductive and inefficient structure in which performance is judged based on demand after product launch. Even the structure is led by the opinions of some experts in the company and often depends on the subjective experience of a few. Accordingly, it is unclear whether new products developed in this way will be able to meet the needs of consumers and the market after launch due to market uncertainty.

Companies recognize the need for a sales volume forecasting tool, which is a criterion for evaluating new product development, but there is no tool that meets this requirement yet, so there is a limit to identifying and proposing a new product profile that maximizes the sales volume.

As a prior patent, in Korean Patent No. 10-2289398 (Design aesthetic evaluation system based on customized big data analysis for new product development), there is disclosed a new product development process that is only structured to judge performance through demand after product launch.

### SUMMARY

In view of the above, the present disclosure provides a predictive new product development method and device for developing a model that predicts the effect of a combination of differentiated features of a new product on initial sales volume after launch, and inductively proposing a new product profile that maximizes demand through the model.

A predictive new product development method of the present disclosure comprises: calculating a new product differentiation index (PDI) by calculating a consumer satisfaction coefficient for each feature of a new product and a degree of differentiation of each feature through a differentiation index calculation unit; calculating a demand creation index (DCI) through a relative ratio of sales volume generated by the new product compared to a predecessor product by a demand creation index calculation unit; building a demand forecasting model through Gaussian process regression of the calculated new product differentiation index (PDI) and the calculated demand creation index (DCI) by a demand forecasting model building unit; and deriving an optimal profile for the new product using the demand forecasting model through an optimal profile deriving unit.

A predictive new product development device of the present disclosure comprises: a differentiation index calculation unit that calculates how differentiated a feature included in a new product is compared to a predecessor product; a demand creation index calculation unit that calculates a ratio of the difference in initial sales volume of the predecessor product and the new product; a demand forecasting model building unit that builds a new product differentiation index (PDI) and a demand creation index (DCI) through Gaussian process regression; and an optimal profile deriving unit that predicts sales volume of the new product with new functions using a demand forecasting model built through the demand forecasting model building unit, wherein the optimal profile deriving unit selects a most recently released predecessor product or a predecessor product to be innovated, configures features to be added or improved to the new product compared to the corresponding predecessor product in various scenarios, calculates the new product differentiation index using a value obtained through each planned feature scenario, and predicts initial sales volume by using the new product differentiation index as test data for the demand forecasting model.

### Advantageous Effects

According to the present disclosure, it is possible to effectively improve the new product development process by deriving the product profile that maximizes future demand creation at the very early stage of new product development through an objective development method based on data analysis.

According to the present disclosure, it is possible to sufficiently reflect market needs in model learning for products that will maximize future demand creation at the very early stage of new product development by reflecting the market response in the predictive model.

### BRIEF DESCRIPTION OF THE DRAWINGS

FIG. 1 is a flowchart illustrating a method of deriving a profile optimized for a new product using a demand forecasting model in a predictive new product development method according to one embodiment of the present disclosure.

FIG. 2 is a block diagram of a predictive new product development device according to one embodiment of the present disclosure.

FIG. 3 is a flowchart illustrating a method of deriving an optimal profile for a new product using the demand forecasting model according to one embodiment of the present disclosure.

### DESCRIPTION OF EXEMPLARY EMBODIMENTS

Specific structural or functional descriptions of embodiments according to the concept of the present disclosure disclosed in the present specification are only illustrated for the purpose of explaining the embodiments according to the concept of the present disclosure, and the embodiments according to the concept of the present disclosure may be implemented in various forms and are not limited to the embodiments described herein.

The embodiments according to the concept of the present disclosure may apply various changes and have various forms, so the embodiments are illustrated in the drawings and described in detail in the present specification. However, this is not intended to limit the embodiments according to the concept of the present disclosure to specific disclosure forms, and the embodiments according to the concept of the present disclosure include all changes, equivalents, or substitutes included in the idea and technical scope of the present disclosure.

The terms used in the present specification are merely used to describe specific embodiments and are not intended to limit the present disclosure. Singular expressions include plural expressions unless the context clearly indicates otherwise. In the present specification, it should be understood that terms such as “comprise or include” or “have” are intended to designate the presence of features, numbers, steps, operations, components, parts, or combinations thereof described in the present specification, without excluding in advance the possibility of the presence or addition of one or more other features, numbers, steps, operations, components, parts, or combinations thereof.

Hereinafter, embodiments of the present disclosure will be described in detail with reference to the drawings attached to this specification.

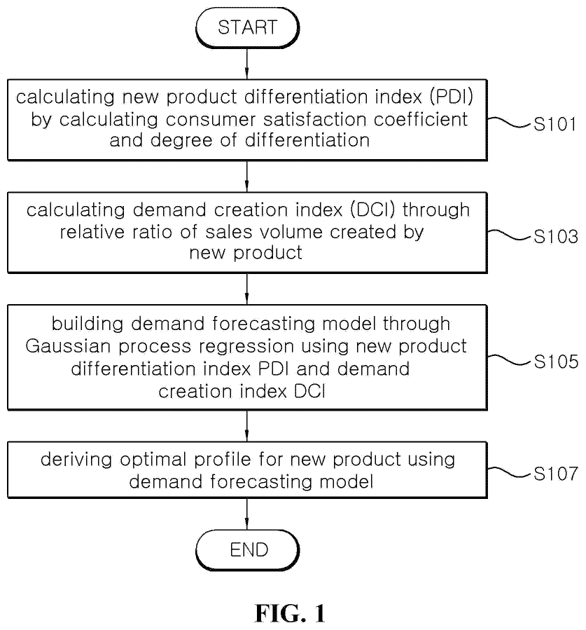

FIG. 1 is a flowchart illustrating a method of deriving a profile optimized for a new product using a demand forecasting model in a predictive new product development method according to one embodiment of the present disclosure. Referring to FIG. 1, the predictive new product development method first calculates a new product differentiation index (PDI) by calculating a consumer satisfaction coefficient and a degree of differentiation in a differentiation index calculation unit 110 (S101).

The new product differentiation index (PDI) measures how differentiated the features included in a new product are compared to predecessor products. To calculate the new product differentiation index (PDI), the consumer satisfaction coefficient and the degree of differentiation for each feature are used as weights.

First, in order to obtain the consumer satisfaction coefficient, a consumer satisfaction coefficient calculation module 111 uses a method that can precisely identify consumer requirements, such as the KANO model, to reflect the importance of each feature from the consumer's perspective. Since the KANO model can systematically explain consumers' reactions to products by expressing them as dual perceptions of satisfaction and dissatisfaction, it is used in various ways in the field of new product development for the purpose of analyzing consumer responses for each feature of a product. The KANO model evaluates each feature of a product using six quality elements, as shown in Table 1 below, according to the impact of the satisfaction of each product feature on consumer satisfaction.

TABLE 1

| Quality Element | Explanation |
|---|---|
| Attractive Quality | The type of feature of product that gives |
| Element (A) | consumer unexpected satisfaction. If |
| | consumer is satisfied, consumer |
| | satisfaction increases significantly, and if |
| | not satisfied, consumer satisfaction |
| | decreases little. |
| One-Dimensional | The general type of product. If |
| Quality Element (O) | consumer is satisfied, consumer |
| | satisfaction increases, and if not satisfied, |
| | consumer satisfaction decreases. |
| Must-be Quality | The feature of product that consumer |
| Element (M) | takes for granted to be satisfied. If the |
| | consumer is not satisfied, consumer |
| | satisfaction decreases significantly, and if |
| | satisfied, consumer satisfaction increases |
| | little. |
| Indifferent Quality | The feature of product that consumer is |
| Element (I) | not interested in. Regardless of whether |
| | consumer is satisfied or not, the |
| | consumer's sense of satisfaction is not |
| | changed. |
| Reverse Quality | The feature of product in the opposite |
| Element (R) | concept of One-Dimensional Quality |
| | Element. If consumer is satisfied, |
| | consumer satisfaction decreases, and if |
| | not satisfied, consumer satisfaction |
| | increases. |
| Skeptical Quality | The feature of product that consumer is |
| Element (S) | suspected of understanding. Regardless |
| | of satisfaction, consumer may or may not |
| | be satisfied. Not used to measure |
| | satisfaction coefficient |

In order to index the consumer's satisfaction and express it as a consumer satisfaction coefficient, the KANO model classifies the quality elements of each product and then calculates the consumer satisfaction in the consumer satisfaction coefficient calculation module 111 using the following consumer satisfaction coefficient formula.

$$SatisfactionCoefficient = \frac{A + O}{A + O + M + 1}$$

The consumer satisfaction coefficient is derived by calculating the proportion of attractive, one-dimensional quality elements in the sum of all quality element responses, and may determine the consumer satisfaction coefficient for each feature of the product.

Next, the degree of differentiation calculation module 113 determines the degree of differentiation for each feature. Product differentiation proceeds in the form improving certain features or adding new features added to predecessor products. In order to accurately calculate the differentiation index, it is necessary to determine the degree of differentiation applied to each feature of the new product compared to the predecessor product. To this end, it is necessary to distinguish the degree of differentiation for each function of the predecessor product and the new product.

In the present disclosure, features that are equal to or lowered from the predecessor products are classified as ‘no-differentiation’, features that are improved by 20% or less of the predecessor product feature are classified as ‘weak differentiation’, and features that are improved by 20% or more of the predecessor product feature or completely new features added to the predecessor product feature are classified as ‘strong differentiation’. If a feature is difficult to measure numerically, the degree of differentiation is classified based on expert evaluation. As weights for the degree of differentiation for the differentiated feature, 0, 0.2, and 0.7 are assigned to ‘no-differentiation’, ‘weak differentiation’, and ‘strong differentiation’, respectively.

In order to calculate the differentiation index of the new product, the differentiation index calculation unit 110 reflects the two types of weights discussed above, namely, the consumer satisfaction coefficient for each feature of the new product and the degree of differentiation of the new product. A more detailed calculation method is as follows.

First, the differentiation index Ci for each feature of the new product is obtained by multiplying the consumer satisfaction coefficient for each feature with the value of the degree of differentiation of the new product. Then, a total differentiation index, which is a value indicating the difference between a new product and a predecessor product as a comprehensive numerical value, is calculated using the differentiation indices for all features, and is referred to as the product differentiation index (PDI) of the new product. This is expressed as the following equation.

$${C}_{i} = Satisfaction {Coefficient}_{i} \times Degree of {Differentiation}_{i} ]$$

$$i = 1 , … , n$$

where, n is the number of differentiated features in the new product among those selected as core features of the product.

$$Product Differentiation Index = \sqrt{{\sum }_{i = 1}^{n} {( {C}_{i} )}^{2}}$$

The differentiation index (PDI) of the new product requires a normalization process in order to use the differentiation index (PDI) between the predecessor product and the new product in modeling with the demand creation index. The comprehensive differentiation index is calculated based on the Euclidean distance between predecessor and new product features. If the values obtained through this process there is in a wide range, the modeling result could be greatly affected by the values, which may affect the performance of the model.

For normalization of the differentiation index (PDI), maxPDI is obtained by assuming that the new product has all the core features improved from the predecessor product to the maximum. In other words, maxPDI is obtained by calculating PDI on the assumption that all core features and functions have strong differentiation. Conversely, minPDI is obtained by assuming that the new product has little improvement of all core features and functions from the predecessor product. In other words, minPDI is obtained by calculating PDI on the assumption that all core features and functions are basic. As a result, it can be seen that minPDI is 0 in all situations. Finally, the normalized value z of the differentiation index PDI between the predecessor product and the new product may be obtained using PDI, maxPDI, and minPDI.

$$z = \frac{PDI - min PDI}{max PDI - min PDI}$$

Next, in order to predict demand through the previously derived differentiation index PDI of the new product, a demand creation index calculation unit 120 calculates a demand creation index DCI through a relative ratio of the sales volume created by the new product (S103).

The demand creation index DCI refers to a value obtained by expressing the differentiation index PDI of the new product as the ratio of the difference between the initial sales volume of the predecessor product and the new product, and the following formula represents the demand creation index DCI of the new product. When the demand creation index DCI is 0, it means that the sales volume of the predecessor product is the same, and a positive value greater than 0 indicates that the sales volume of the new product is greater than that of the predecessor product, and a negative value less than 0 indicates that the sales volume of the new product is smaller than that of the predecessor product.

$$Demand Creation Index = \frac{New Product Demand - Predecessor Product Demand}{Predecessor Product Demand}$$

Next, a demand forecasting model building unit 130 builds a demand forecasting model through Gaussian process regression (S105). Through the above demand forecasting model, the sales volume of a new product with new functions can be predicted, which may be used to select the function that can maximize sales performance among the candidate functions of the next new product.

For building the demand forecasting model, in order to predict the demand creation index (DCI) using the previously obtained new product differentiation index (PDI), an algorithm that can accurately model the relationship between the two is used. Various previous arguments show that the relationship between product differentiation and demand is not a linear relationship, and in particular, market data related to new products are complex and have stronger non-linear characteristics. In the present disclosure, the Gaussian process is selected as an optimal model.

The Gaussian process regression model is a non-parametric model that solves non-linear problems and is a representative regression model that generates an advanced predictive model even with a small amount of data. Unlike general machine learning models, the Gaussian process regression model is a non-parametric model that depends on a small number of parameters in generating a predictive model. The Gaussian process is a technique for generating the latent variable f (Xi) of the Gaussian process for the observed value Xi and predicting the y value by introducing an explicit basis function h. When expressed as a formula, it takes the form below.

$$f ( Xi ) = GP ( m ( X ) , k ( X , {X}^{′} ) )$$

In the above formula, m (X) expresses the mean, k (X,X′) means the covariance, and the Gaussian process is characterized by using the mean and covariance function to find the distribution corresponding to the confidence interval of the predicted value and to perform a prediction by deriving the variance of the distribution. Even when a small amount of data is learned, a number of computations are performed to calculate each similarity, which results in higher performance than a general predictive model, so the Gaussian process regression model can be effectively used in cases such as predicting new products.

The Gaussian process is derived using the above calculation formula and is combined with the regression equation as follows. In this case, h is an explicit basis function that describes the response variable for each observation.

$$y = {hX}^{′} β + f ( X )$$

Finally, Bayes' theorem is used in the corresponding equation to derive the optimal y value reflecting the existing results, that is, the final predicted value of DCI. The DCI forecast value derived in this way is multiplied by the demand for the predecessor product to calculate the final result of the model, that is, the predicted demand for the first quarter after the launch of the new product. This is expressed in the equation as follows.

$$Initial Demand Prediction = Predicted DCI \times Predecessor Product Demand + Predecessor Product Demand$$

Finally, an optimal profile deriving unit 140 derives an optimal profile for the new product using the demand forecasting model built through Gaussian process regression in the an optimal profile deriving unit 140 (S107).

To derive the optimal profile of the new product, the following processes are performed. First, the most recently released predecessor product or the predecessor product to be innovated is selected, and the features to be added or improved to a new product compared to the selected product are configured in various scenarios. At this time, the satisfaction coefficient for new features to be included in the new product needs to be obtained in advance through the KANO survey and used as a weight during model learning. Second, a new product differentiation index is obtained by using the values obtained through each feature scenario previously planned, and the new product differentiation index is used as test data for the demand forecasting model proposed in the present disclosure to predict initial sales volume. Based on each initial sales volume obtained in this process, a combination of features that maximizes sales volume is derived, which becomes the most likely candidate for the new product profile. With respect to the derived new product profile, a company's product planning manager determines the direction of new product development through decision-making. This method can effectively improve the new product development process by deriving a product profile that can maximize sales after launch at the very early stages of new product development.

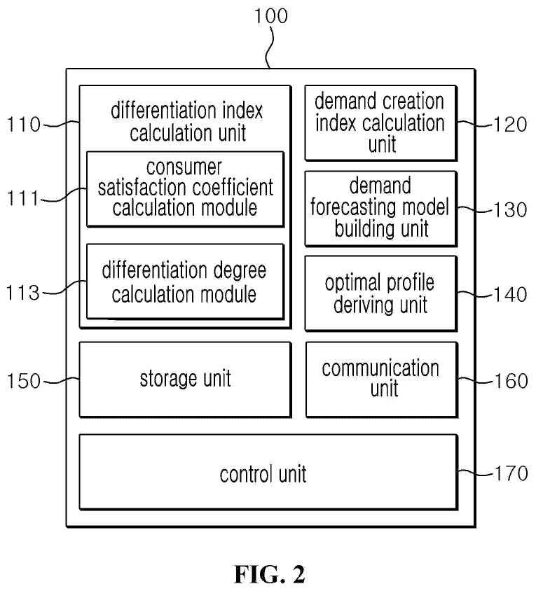

FIG. 2 is a block diagram of a predictive new product development device 100 according to one embodiment of the present disclosure. Referring to FIG. 2, the predictive new product development device 100 includes a differentiation index calculation unit 110, a demand creation index calculation unit 120, a demand forecasting model building unit 130, an optimal profile deriving unit 140, and a storage unit 150, a communication unit 160, and a control unit 170.

The differentiation index calculation unit 110 calculates a new product differentiation index (PDI) to measure how differentiated the features included in a new product are compared to predecessor products. The new product differentiation index (PDI) uses the consumer satisfaction coefficient and the degree of differentiation for each feature as weights. The differentiation index calculation unit 110 includes a consumer satisfaction coefficient calculation module 111 and a differentiation degree calculation module 113. Details of the differentiation index calculation unit 110 will be described later.

The consumer satisfaction coefficient calculation module 111 calculates the consumer satisfaction coefficient using a method that can precisely identify consumer requirements, such as the Kano model, to reflect the importance of each feature from the consumer's perspective. In order to index consumer satisfaction using the KANO model and express it as a consumer satisfaction coefficient, the quality elements of each product are classified and then calculated using the consumer satisfaction coefficient formula.

The differentiation degree calculation module 113 calculates the degree of differentiation for each function of the predecessor product and the new product in order to determine the degree of differentiation for each feature. As weights for the degree of differentiation, 0, 0.2, and 0.7 are assigned to ‘no-differentiation’, ‘weak differentiation’, ‘strong differentiation’, respectively. The ‘no-differentiation’ refers to features that are equal to or lowered from the predecessor products, the ‘weak differentiation’ refers to the features that are improved by 20% or less of the predecessor product feature, and the ‘strong differentiation’ refers to the features that are improved by 20% or more of the predecessor product feature or added completely new features. If a feature is difficult to measure numerically, the degree of differentiation is classified based on expert evaluation.

The differentiation index calculation unit 110 multiplies the consumer satisfaction coefficient for each feature obtained from the consumer satisfaction coefficient calculation module 111 by the value of the degree of differentiation of the new product obtained from the differentiation degree calculation module 113, calculates the differentiation index Ci for each feature of the new product, and then uses the differentiation indices for all features to calculate a comprehensive differentiation index, which is a value indicating the difference between the new product and the predecessor product as a comprehensive numerical value. Then, since a normalization process is needed for demand creation index and modeling, using PDI, maxPDI, minPDI, the normalized value z of the differentiation index PDI between the predecessor product and the new product is calculated.

The demand creation index calculation unit 120 calculates a demand creation index DCI through a relative ratio of the sales volume generated by the new product to predict demand through the previously derived differentiation index PDI of the new product.

The demand forecasting model building unit 130 builds a demand forecasting model through Gaussian process regression, so that it can predict the sales volume of the new product with new functions and identify the function that can maximize sales performance among candidate functions for the next new product.

The optimal profile deriving unit 140 derives an optimal profile for the new product using the demand forecasting model built through Gaussian process regression in the demand forecasting model building unit 130.

The storage unit 150 stores each component value of processes related to building a demand forecasting model.

The communication unit 160 communicates, on a network, with the predictive new product development device 100, a service providing server, and other user terminals, and receives information to study a highly complete predictive model that reflects data through product users' satisfaction with each function using the results of the KANO model as weights. The network includes a local area network (LAN), a wide area network (WAN), a value added network (VAN), a mobile radio communication network, a satellite communication network, and combinations thereof. The network is a data communication network in a comprehensive sense and may include wired Internet, wireless Internet, and mobile wireless communication networks. In addition, wireless communications include, for example, wireless LAN (Wi-Fi), Bluetooth, Bluetooth low energy, ZigBee, Wi-Fi Direct (WFD), ultra wideband (UWB), and infrared Data Association (IrDA), Near Field Communication (NFC), and the like, but are not limited thereto.

The control unit 170 controls the processing of processes related to building the demand forecasting model and controls the operation of each component.

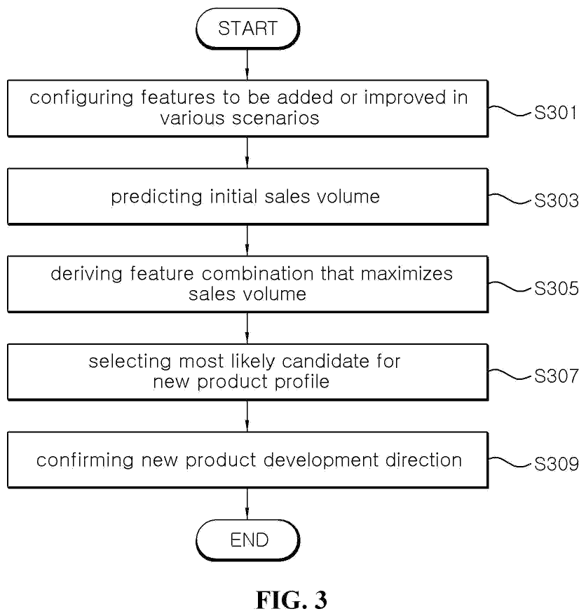

FIG. 3 is a flowchart illustrating the process of deriving an optimal profile for the new product in the optimal profile deriving unit 140. First, the most recently released predecessor product or a predecessor product to be innovated is selected and the features to be added or improved in a new product compared to the selected product are configured in various scenarios (S301). Then, each planned feature scenario is used as test data for the predictive model proposed in the present disclosure, and the initial sales volume is predicted (S303). A feature combination that maximizes sales volume is derived based on each initial sales volume obtained (S305). The derived feature combination is selected as the most likely candidate for the new product profile

(S307). The new product development direction is confirmed through decision-making on the selected candidate (S309).

Below is an example of application to a smartwatch new product development case to verify the effectiveness of the predictive new product development method and system according to the present disclosure. Smartwatches are suitable for applying the present disclosure since, due to the nature of the product, new products are regularly and consistently released in the same product line, and it is a development field in which planning for innovative functions frequently occurs.

In this study, data from Apple Watch and Samsung Electronics' Galaxy Watch, for which it is relatively easy to obtain data and for which there are sufficient comparable new product series, are selected as the subject of analysis. The analyzed products include Apple Watch Series 1-7 and Apple Watch SE, which were new products released from September 2014, and Galaxy Watch Series 1-3, Galaxy Watch Active 1-2, and Galaxy Watch Classic, which were released from August 2018. The analysis was conducted based on data from the Korean region. Korea has a high level of maturity in IT technology and is used as a test bed for new IT products, so many studies use data from the Korean market.

First, to calculate PDI, the consumer satisfaction coefficient and the degree of differentiation by product feature are obtained. A total of 20 smartwatch core features were selected based on preliminary interviews with experts and potential users.

KANO survey data is used to obtain consumer satisfaction coefficients for each feature. Referring to Table 2, responses to the positive and negative questions of the KANO model were received on a 5-point Likert scale. Based on the corresponding KANO survey data, quality elements and satisfaction coefficients for a total of 20 smartwatch features were calculated.

TABLE 2

| | | | | | | | Satisfaction |
|---|---|---|---|---|---|---|---|
| Features | Q | A | I | M | O | R | Coefficient |
| Launching Price (Won) | 2 | 71 | 39 | 10 | 31 | 7 | 0.6755 |
| Weight (g) | 2 | 40 | 16 | 31 | 70 | 1 | 0.7006 |
| Battery (mAh) | 3 | 45 | 12 | 9 | 89 | 2 | 0.8645 |
| Display resolution | 1 | 32 | 32 | 18 | 76 | 1 | 0.6835 |
| RAM | 1 | 54 | 42 | 6 | 57 | 0 | 0.6981 |
| Memory | 0 | 55 | 50 | 10 | 44 | 1 | 0.6226 |
| Design (Score) | 1 | 25 | 8 | 7 | 119 | 0 | 0.9057 |
| OS | 0 | 51 | 37 | 9 | 63 | 0 | 0.7125 |
| Wi-Fi | 1 | 42 | 19 | 17 | 81 | 0 | 0.7736 |
| Bluetooth | 0 | 27 | 15 | 22 | 93 | 3 | 0.7643 |
| Cellular Connectivity | 3 | 14 | 5 | 58 | 80 | 0 | 0.5987 |
| Electrical Heart Rate | 0 | 58 | 21 | 12 | 68 | 1 | 0.7925 |
| VO2max | 1 | 70 | 28 | 8 | 51 | 2 | 0.7707 |
| ECG app | 2 | 72 | 40 | 6 | 37 | 3 | 0.7032 |
| Stress Measurement | 1 | 94 | 27 | 2 | 32 | 4 | 0.8129 |
| Fall Detection | 0 | 95 | 17 | 4 | 41 | 3 | 0.8662 |
| Multisports Mode | 3 | 61 | 13 | 23 | 60 | 0 | 0.7707 |
| Water Intake | 2 | 86 | 24 | 3 | 44 | 1 | 0.8280 |
| Calorie Intake | 2 | 88 | 23 | 0 | 46 | 1 | 0.8535 |
| Irregular Heart Rate | 0 | 90 | 21 | 0 | 47 | 2 | 0.8671 |
| Warnings | | | | | | | |

Q: Skeptical Quality Element,
A: Attractive Quality Element,
I: Indifferent Quality Element,
M: Must-Be Quality Element,
O: One-Dimensional Quality Element,
R: Reverse Quality Element

Next, the degree of differentiation for each feature is identified. To determine the degree of differentiation, a combination of the new products and the predecessor product is needed. Referring to Table 3, as an example of the level of improvement between the predecessor product 5 and the new product carried out in the present disclosure, the degree of differentiation of some features for Apple Watch Series 3 and Apple Watch Series 4 is distinguished. Based on the criteria described above, 0.2 is assigned to weak differentiation and 0.7 to strong differentiation.

TABLE 3

| | | | Differentiation |
|---|---|---|---|
| | Satisfaction | Degree of | Index by |
| Feature | Coefficient | Differentiation | Feature |
| Launching Price (Won) | 0.6755 | 0 | 0 |
| Weight (g) | 0.7006 | 0.7 | 0.4904 |
| Battery (Duration) | 0.8645 | 0 | 0 |
| Display resolution | 0.6835 | 0.7 | 0.4785 |
| RAM | 0.6981 | 0.2 | 0.1396 |
| Memory | 0.6226 | 0.2 | 0.1245 |
| Design (Score) | 0.9057 | 0.2 | 0.1811 |
| OS | 0.7125 | 0.7 | 0.4988 |
| Wi-Fi | 0.7736 | 0 | 0 |
| Bluetooth | 0.7643 | 0 | 0 |
| Cellular Connectivity | 0.5987 | 0 | 0 |
| Electrical Heart Rate | 0.7925 | 0.7 | 0.5395 |
| VO2max | 0.7707 | 0 | 0 |
| ECG app | 0.7032 | 0 | 0 |
| Stress Measurement | 0.8129 | 0 | 0 |
| Fall Detection | 0.8662 | 0.7 | 0.6064 |
| Multi-sports Mode | 0.7707 | 0 | 0 |
| Water Intake | 0.8280 | 0 | 0 |
| Calorie Intake | 0.8535 | 0 | 0 |
| Irregular Heart Rate | 0.8671 | 0 | 0 |
| Warnings | | | |

| | |
|---|---|
| Total Differentiation Index of New Product | 1.2020 |

The differentiation index for each feature can be obtained by multiplying the satisfaction coefficient for each feature obtained previously by the degree of differentiation. For features where differentiation has not occurred, the degree of differentiation becomes 0, so the differentiation index for each feature also becomes 0, and for differentiated features, a ‘differentiation index for each feature’ is calculated according to the degree of differentiation and the consumer satisfaction coefficient. Table 3 is an example of calculating the differentiation index by each feature of the new product for Apple Watch Series 4 compared to Apple Watch 3. Then, the PDI of the new product is obtained by calculating the total differentiation index using the differentiation index for each feature of the new product.

For modeling the differentiation index and the demand creation index of the new product, the differentiation index is normalized. When comparing a new smartwatch to an existing smartwatch, maxPDI is calculated assuming that all functions are strongly differentiated, and minPDI is calculated assuming that no differentiation has been observed at all. The differentiation index of the new product is normalized using maxPDI and minPDI. Table 4 is an example of calculating the normalized value z for the differentiation index of Apple Watch 4 compared to Apple Watch 3.

TABLE 4

| PDI | maxPDI | minPDI | z |
|---|---|---|---|
| 1.2020 | 2.7492 | 0 | 0.4372 |

To calculate the rate of change in sales of new smartwatches compared to predecessor smartwatches, or DCI, the initial demands for predecessor products and new products in pairs are listed using smartwatch sales data. DCI uses a value obtained by dividing the initial demand for the new product by the initial demand for the predecessor product in each observation location to measure the rate of change in sales volume. This becomes the dependent variable for model learning. Table 5 is an example of calculating the DCI value of smartwatch data released by 10 Apple.

TABLE 5

| Model | | Predecessor | New | |
|---|---|---|---|---|
| New | Predecessor | Product | Product | |
| product | product | Demand | Demand | DCI |
| Apple watch 4 | Apple watch 3 | 1092030 | 873727 | −0.20 |
| Apple watch 5 | Apple watch 3 | 1092030 | 3156387 | 1.89 |
| Apple watch 6 | Apple watch 3 | 1092030 | 2746727 | 1.515 |
| Apple watch SE | Apple watch 3 | 1092030 | 1610277 | 0.475 |
| Apple watch 7 | Apple watch 3 | 1092030 | 3786952 | 2.468 |
| Apple watch 5 | Apple watch 4 | 873727 | 3156387 | 2.613 |
| Apple watch 6 | Apple watch 4 | 873727 | 2746727 | 2.144 |
| Apple watch SE | Apple watch 4 | 873727 | 1610277 | 0.843 |
| Apple watch 7 | Apple watch 4 | 873727 | 3786952 | 3.334 |
| Apple watch 6 | Apple watch 5 | 3156387 | 2746727 | −0.13 |
| Apple watch SE | Apple watch 5 | 3156387 | 1610277 | −0.49 |
| Apple watch 7 | Apple watch 5 | 3156387 | 3786952 | 0.20 |
| Apple watch SE | Apple watch 6 | 2746727 | 1610276 | −0.414 |
| Apple watch 7 | Apple watch 6 | 2746727 | 3786952 | 0.379 |
| Apple watch 7 | Apple watch SE | 1610276 | 3786952 | 1.352 |

Once the PDI and DCI of a new smartwatch are prepared, a work for building a predictive model by fitting the relationship between the two indices is performed. For high-quality predictive modeling, 23 complete data points excluding outliers are selected in the data preprocessing process, 80% of which are used as training data, and the remaining 20% are used as test data. At this time, the test data is randomly extracted, but set not to predict the same new product, so that it can predict as diverse smartwatches as possible.

After completing the data preprocessing process for model learning, a Gaussian process regression predictive model is created. In this process, Gaussian process regression draws a prediction trend line and can make predictions on the 20% of test data selected previously.

Referring to Table 6, the results of the Gaussian process regression predictive model proposed in this study as an example of smartwatch new product development can be confirmed.

TABLE 6

| Testing Model | | | | | |
|---|---|---|---|---|---|
| | Predecessor | DCI | DCI | Initial Demand | Initial Demand |
| New Product | Product | (Actual) | (Predicted) | (Actual) | (Predicted) |
| Apple Watch 5 | Apple Watch 4 | 2.61 | 3.01 | 3,156,387 | 3,503,821 |
| Apple Watch 6 | Apple Watch 3 | 1.51 | 1.12 | 2,746,727 | 2,320,689 |
| Apple Watch 7 | Apple Watch SE | 1.35 | 1.20 | 3,786,952 | 3,553,003 |
| Galaxy Watch 4 | Galaxy Watch 3 | 3.29 | 3.05 | 11,111,038 | 10,497,587 |

This study's DCI predictive model using the Gaussian process regression method recorded an accuracy of DCI prediction is 0.097 based on MSE, and the overall mean square error showed high accuracy. The closer the predicted value of DCI is to the actual value, the more directly it affects the initial sales volume prediction for the new product. Accordingly, the final result of the predictive model, that is, the initial sales volume prediction performance also recorded 9.6% based on the MAPE, confirming relatively high prediction performance.

The robustness of the model results was confirmed through cross-validation. The test was repeated with an additional randomized subset of the same size as the base test from the entire dataset. Referring to Table 7, as a result of 5-folds cross-validation (5-folds CV), the average performance of all tests was 0.205 MSE and 12.2% MAPE, maintaining a relatively high level of accuracy.

TABLE 7

| Cross Validation | MSE | MAPE (%) |
|---|---|---|
| CV 1 | 0.097 | 9.568 |
| CV 2 | 0.240 | 12.183 |
| CV 3 | 0.312 | 15.795 |
| CV 4 | 0.191 | 12.574 |
| CV 5 | 0.187 | 11.359 |

Based on the predictive model built in this example, prediction of sales volume for each new product scenario including new features is possible. Referring to Table 8, it can be seen that the first quarter sales prediction after the launch of each new product profile and the sales contribution of the new features. The sales contribution of the new features was calculated using the difference in the predicted sales volume with and without the feature in the Gaussian process regression model. This implies the impact of each new feature on demand.

TABLE 8

| | | Predicted | Demand |
|---|---|---|---|
| | | Demand | Contribution |
| | | (Initial | of New |
| Scenario | New Product Profiles | Quarter) | Feature |
| 1 | Apple Watch 7 + Simultaneous | 5,532,908 | 0.461 |
| | Translation | | |
| 2 | Apple Watch 7 + Pulse Detection | 5,224,844 | 0.644 |
| 3 | Apple Watch 7 + Virus | 5,484,600 | 0.448 |
| | Measurement | | |

The present disclosure has been described with reference to the embodiments shown in the drawings, but these are merely exemplary, and those skilled in the art will understand that various modifications and other equivalent embodiments are possible therefrom. Accordingly, the true technical protection scope of the present disclosure should be determined by the technical idea of the attached claims.

1. A predictive new product development method comprising:
calculating a new product differentiation index (PDI) by calculating a consumer satisfaction coefficient for each feature of a new product and a degree of differentiation of each feature through a differentiation index calculation unit;
calculating a demand creation index (DCI) through a relative ratio of sales volume generated by the new product compared to a predecessor product by a demand creation index calculation unit;
building a demand forecasting model through Gaussian process regression of the calculated new product differentiation index (PDI) and the calculated demand creation index (DCI) by a demand forecasting model building unit; and
deriving an optimal profile for the new product using the demand forecasting model through an optimal profile deriving unit
wherein the new product differentiation index (PDI) is a value that expresses the difference between a new product and an existing product as a comprehensive value,
wherein the new product differentiation index (PDI) is calculated by multiplying the consumer satisfaction coefficient for each feature by a value of the degree of differentiation of the new product to obtain a differentiation index (Ci) for each feature of the new product, and using the differentiation indices for all features through the following formula,
a degree of differentiation of a new product is calculated by calculating the degree of differentiation between each function of the existing product and the new product, a weights for the degree of differentiation for the differentiated feature, 0, 0.2, and 0.7 are assigned to ‘no-differentiation’, ‘weak differentiation’, and ‘strong differentiation’, respectively.
$$Product Differentiation Index = \sqrt{{\sum }_{i = 1}^{n} {( {C}_{i} )}^{2}}$$
(i=1, . . . , n, and n is the number of differentiated features in the new product among those selected as core features of the product.)

2. The predictive new product development method of claim 1, wherein in the deriving of the optimal profile for the new product, a most recently released predecessor product or an predecessor product to be innovated is selected, a combination of features to be added or improved to the new product compared to the corresponding predecessor product is configured into various scenarios, the new product differentiation index is obtained from a value obtained through each planned feature scenario, and the new product differentiation index is used as test data for the demand forecasting model to predict initial sales volume.

3. The predictive new product development method of claim, wherein in the deriving of the optimal profile for the new product, a feature combination that maximizes sales volume is derived based on each initial sales volume obtained, the derived feature combination is selected as a most likely candidate for a new product profile, and a new product development direction is confirmed through decision-making on the selected candidate.

4. (canceled)

5. A predictive new product development device comprising:
a differentiation index calculation unit that calculates how differentiated a feature included in a new product is compared to a predecessor product;
a demand creation index calculation unit that calculates a ratio of the difference in initial sales volume of the predecessor product and the new product;
a demand forecasting model building unit that builds a new product differentiation index (PDI) and a demand creation index (DCI) through Gaussian process regression; and
an optimal profile deriving unit that predicts sales volume of the new product with new functions using a demand forecasting model built through the demand forecasting model building unit,
wherein the optimal profile deriving unit selects a most recently released predecessor product or a predecessor product to be innovated, configures features to be added or improved to the new product compared to the corresponding predecessor product in various scenarios, calculates the new product differentiation index using a value obtained through each planned feature scenario, and predicts initial sales volume by using the new product differentiation index as test data for the demand forecasting model,
wherein the new product differentiation index (PDI) is a value that expresses the difference between a new product and an existing product as a comprehensive value, wherein the differentiation index calculation unit calculates the degree of differentiation of each function of the existing product and the new product as a numerical value of the degree of differentiation of the new product, a weights for the degree of differentiation for the differentiated feature, 0, 0.2, and 0.7 are assigned to ‘no-differentiation’, ‘weak differentiation’, and ‘strong differentiation’.
